(19) United States
(12) Patent Application Publication
(10) Pub. No.: US 2003/0149703 A1
(43) Pub. Date: Aug. 7, 2003

(54) System and method for generating high-quality libraries

(75) Inventor: William E. Corr, Twickenham (GB)

Correspondence Address: Brett A. Carlson, Snell & Wilmer L.L.P., One Arizona Center, 400 East Van Buren, Phoenix, AZ, 85004-2202, US

(73) Assignee: Micron Technology, Inc., Boise, ID (US)

(21) Appl. No.: 10/106,756

(22) Filed: Mar. 26, 2002

(30) Foreign Application Priority Data
Feb. 1, 2002 (GB) 0202329.9

(51) Int. Cl. G06F 7/00

(52) U.S. Cl. 707/102

(57) ABSTRACT

An exemplary method of creating a cell library suitably includes, for each of a plurality of cells, determining a status of the cell and indicating the status with an electronic record. The electronic record associated with each of the cells is validated, and the validated cells are compiled to create the cell library. Testing may include manual testing of datasheets and the like, as well as electronic test of the cell design. According to yet another aspect of the invention, a method of creating a cell library suitably includes testing one or more cells to determine a status of the cell and to record the status in a data file associated with the cell, and compiling said plurality of cells to create the cell library, wherein the compiling step includes verifying the data file for each of the plurality of cells and including in the cell library only those cells having an associated data file that is free of error indicia.

An exemplary system for creating a cell library suitably includes an input device configured to receive inputs from a user, a database configured to store cell design data and metadata associated with the cell design data, and a digital storage medium containing computer-executable instructions stored thereon, wherein the instructions are configured to receive the inputs from the input device, to store the inputs in the metadata, and to integrate the cell design data as a function of the metadata to create the cell library.

### FIELD OF INVENTION

The invention relates generally to systems and methods for creating electronic libraries of design components. In an exemplary embodiment, the invention relates to systems and methods for creating cell libraries used in the computer-aided design of integrated circuits.

### BACKGROUND OF THE INVENTION

Integrated circuits (ICs) such as microprocessors, digital memories and other so-called “computer chips” have become commonly used in cars, computers, watches, telephones, medical devices and countless other devices. Indeed, the use of electronics devices incorporating integrated circuitry has become commonplace in industrial, medical, aerospace, defense, and consumer settings, as well as in virtually every other commercial field. As the term “integrated circuit” implies, a typical IC is made up of hundreds, thousands or even millions of separate circuit components (e.g. transistors, diodes, capacitors, resistors and the like) that are formed on a semi-conducting substrate and interconnected to process data.

For various economic reasons (including, for example, a desire to avoid the cost, complexity and spatial requirements of manufacturing integrated circuits), many designers in recent years have opted for the “intellectual property” (IP) model of circuit design. In such a model, designers produce chip or circuit designs in electronic form rather than in physical, manufactured form. The electronic designs may then be used by system integrators, component manufacturers or the like to create products using the suppliers' designs without requiring the supplier to fabricate and ship a physical embodiment of the design.

Frequently, electronic designs are provided as “cell libraries”, or collections of design components (i.e. cells) that may be incorporated into larger designs prepared by the customer. Individual cells are typically created, modeled and tested before being incorporated into the digital library. The value of the cell library, then, is generally dependent at least in part upon the accuracy and reliability of each individual cell. Cell library producers have of course endeavored to create products that are as reliable as possible. In particular, various testing procedures have focused on cell accuracy and reliability. Nevertheless, cell tests have not typically been considered at the time that cells are integrated into a common library. The possibility therefore exists that an untested cell or a cell that failed one or more tests may become automatically integrated into a cell library. It is therefore desirable to create systems and techniques for creating high-quality cell libraries that avoid the shortcomings of prior art systems and techniques.

### SUMMARY OF THE INVENTION

According to one aspect of the invention, a method of creating a cell library suitably includes, for each of a plurality of cells, determining a status of the cell and indicating the status with an electronic record. The electronic record associated with each of the cells is validated, and the validated cells are compiled to create the cell library. Testing may include manual testing of datasheets and the like, as well as electronic test of the cell design.

According to another aspect of the invention, a method of creating a library suitably includes testing a library component, recording results of the testing in a data file associated with the library component, verifying that the data file is complete and free of error indications, and incorporating the library component into the library if the verification is successful, and otherwise rejecting the library component from the library.

According to a further aspect of the invention, a system for creating a cell library suitably includes an input device configured to receive inputs from a user, a database configured to store cell design data and metadata associated with the cell design data, and a digital storage medium containing computer-executable instructions stored thereon, wherein the instructions are configured to receive the inputs from the input device, to store the inputs in the metadata, and to integrate the cell design data as a function of the metadata to create the cell library.

According to yet another aspect of the invention, a method of creating a cell library suitably includes testing one or more cells to determine a status of the cell and to record the status in a data file associated with the cell, and compiling said plurality of cells to create the cell library, wherein the compiling step includes verifying the data file for each of the plurality of cells and including in the cell library only those cells having an associated data file that is free of error indicia.

### BRIEF DESCRIPTION OF THE DRAWINGS

The features and advantages of the present invention are hereinafter described in the following detailed description of illustrative embodiments to be read in conjunction with the accompanying drawing figures, wherein like reference numerals are used to identify the same or similar parts in the similar views, and:

FIG. 1 is a block diagram of an exemplary system for creating cell libraries;

FIG. 2 is a flowchart of an exemplary process for creating a cell library;

FIG. 3 is an exemplary database structure for cell metadata; and

FIG. 4 is a pseudo-code description of an exemplary cell-checking process.

### DETAILED DESCRIPTION

According to various exemplary embodiments of the invention, systems and methods for creating libraries for use in computer-aided design environments suitably include maintaining data about tests performed for each cell so that testing and accuracy of the cell may be verified before the cell is integrated into the library product. Information about tests performed may be maintained in a metadata file, a data tag or any other mechanism that may be checked at a later time to ensure that a full battery of tests has been performed on the cell and that the cell passed each test successfully. Cells that fail to properly verify may be excluded from the library until such tests are completed, as appropriate. By making successful verification of cell testing a condition of inclusion in the library, the overall quality of the library is vastly improved.

Various aspects of the present invention may be described herein in terms of functional block components and various processing steps. It should be appreciated that such functional blocks may be realized by any number of hardware and/or software components configured to perform the specified functions. Furthermore, the connecting lines shown in the various figures contained herein are intended to represent exemplary functional relationships and/or physical couplings between the various elements. Many alternative or additional functional relationships or physical connections might be present in a practical library creation system.

The particular implementations shown and described herein are illustrative of various exemplary embodiments of the invention and are not intended to limit the scope of the invention in any way. Indeed, for the sake of brevity, conventional computer system architecture, application development and other functional aspects of the systems (and components of the individual operating components of the systems) may not be described in detail herein. For example, the software elements described herein be implemented with any programming or scripting language such as C, C++, PASCAL, Objective C, Ada, Java, assembler, PERL, PHP, any database programming language, or the like. Similarly, the software and algorithms executed by the various processing components may be implemented with any combination of data structures, files, objects, processes, routines or other programming elements.

To simplify the description of the exemplary embodiments, the invention is frequently described as pertaining to a system of creating cell libraries for use in the design of integrated circuits. It will be appreciated, however, that many applications of the present invention could be formulated. For example, the present invention could be used in any computer aided design environment, such as the design of mechanical or electrical systems, biological systems, or the like. Moreover, various embodiments may be used in applications outside of the CAD environment, such as in conjunction with the creating of software libraries (e.g. dynamically linked libraries (DLLs)) or the like. The term “cell” as used herein, then, should be interpreted broadly to include electronic objects, modules, programs, designs, components or the like that may be combined to form an electronic library.

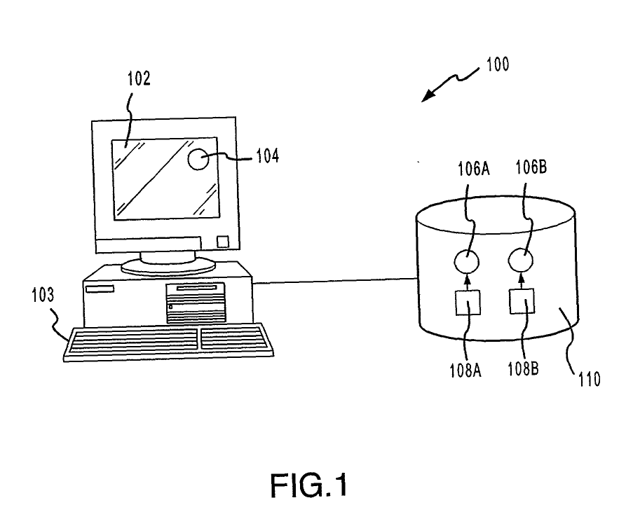

FIG. 1 is a block diagram of an exemplary system for creating cell libraries. With reference now to FIG. 1, an exemplary system 100 for creating cell libraries suitably includes a host computer 102 executing an administrative application 104 and having access to a database 110 storing cell data 106A-B and metadata 108A-B.

Host computer 102 may include any convenient combination of hardware and software components configured to allow a user to verify the various components being integrated to form the library. Host computer 102 may be implemented with any sort of personal computer, workstation or other computing device running any operating system such as any version of the Windows operating system available from the Microsoft Corporation of Redmond, Washington. Alternatively, host computer 102 may execute any version of the UNIX, LINUX, SOLARIS, MacOS, or other operating system. Host computer 102 typically includes one or more input devices 103 such as a keyboard, mouse, touchscreen or the like for receiving inputs from a user, as well as an output device such as a video monitor, printer or the like for displaying feedback to the user. Host computer 102 typically further includes a digital storage medium such as a memory, SRAM, DRAM, hard disk, optical disk, CD-ROM and/or other mass storage device that maintains computer-executable instructions in electronic form. Such instructions may be stored as compiled object code or as interpreted instructions that may be further executed by a microprocessor or other control device. The software applications described herein are examples of computer-executable instructions that may be stored within host computer 102.

Application 104 (also called “administrative application”) is any software program executing within system 102 that is capable of verifying the tests performed on each cell before the cell is included within the resultant library. Application 104 may also compile cells to form the library, and may perform other tasks such as managing data during the cell design process, testing or simulating cell design data, or the like. In an exemplary embodiment, application 104 is a commercially-available project management tool such as the DESIGNSYNC tool available from Synchronicity. Alternatively, application 104 may be implemented with any programming or scripting language such as PERL, PHP or the like. Additional detail about an exemplary embodiment of application 104 is provided below in conjunction with FIG. 4.

Database 110 is a graphical, hierarchical, relational, object-oriented or other database, and may be maintained on a local drive of host computer 102 or on a separate computer coupled to host 102 via a local area or other network (not shown). In an exemplary embodiment, database 110 is implemented using any of the database products available from the Oracle Corporation of Redwood City, Calif., the Microsoft corporation of Redmond, Wash., or any other database product. Alternatively, database 110 is implemented using conventional “flat” files or other files capable of being stored in a file system associated with host computer 102. In such embodiments data associated with each cell or component design may be stored in a common subdirectory in a file tree arrangement, or according to any other scheme. In still other embodiments, database 110 is implemented within a proprietary or open format dictated by application 104 executing on host computer 102.

In an exemplary embodiment, database 110 suitably maintains cell or component design data 106A-B. As described above, the individual cells or components making up the electronic library may be any type of software object, module, design or the like. Design data 106 suitably contains information describing a circuit or other component that may be integrated into a library for later use. In an exemplary embodiment, each cell 106 is an electronic design for an integrated circuit component such as a transistor, diode, amplifier, logic gate or the like. Each cell 106 may be incorporated into a library of design components that may be provided to a customer for inclusion in larger integrated circuit designs, or for any other application. General information about cells and cell libraries may be found in, for example, U.S. Pat. No. 5,802,349, incorporated herein by reference.

Design data 106 may be in any format, including any of the open or proprietary formats used by, for example, AUTOCAD or CADENCE design tools. In many embodiments, design data 106 may be made up of multiple files and/or file formats for each component. A typical cell component, for example, might include a specification in Microsoft Word format, a design document in Cadence format, and various timing files or other data files in other formats. Each of the various files making up design data 106 may be grouped together and stored in a common location, as appropriate.

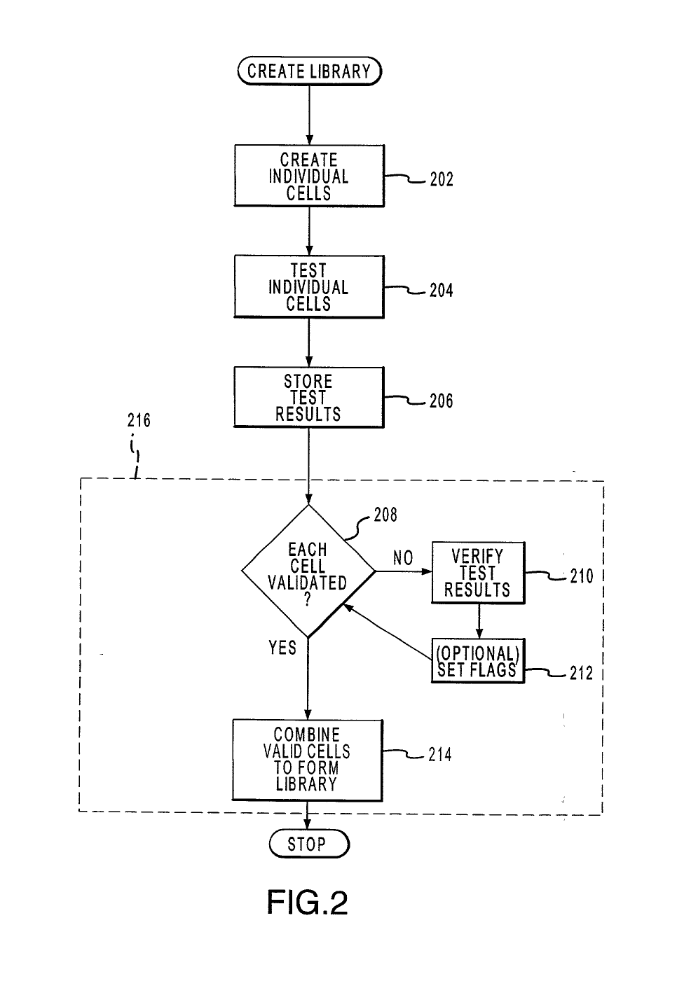

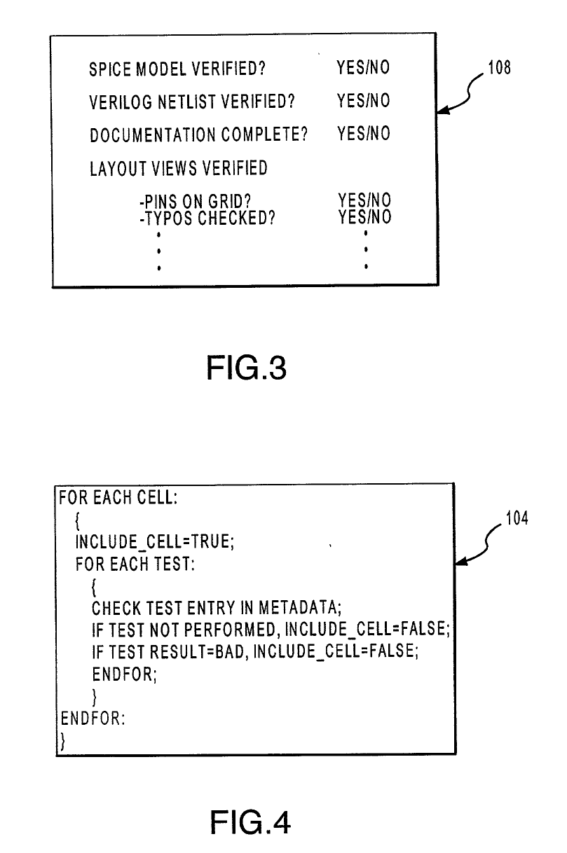

Database 110 further includes metadata 108A-B that is associated with design data 106A-B. As described more fully below, metadata 108A-B is any data that is capable of describing, locating, pointing to or otherwise associating with design data 106A-B. Metadata may be implemented in a proprietary or open format such as an XML document, a flat file or the like. In various embodiments (and as described more fully below, in particular in conjunction with FIGS. 2 and 3), metadata 108 is associated with application 104 and is stored in a common directory with design data 106.

It will be appreciated that many other embodiments of system 100 may be formulated. System 100 could be readily modified to operate in networked or client/server environments, for example. Such embodiments may allow users to remotely design cells or other components 106, to remotely store and retrieve data using database 110, to perform remote tests on components 106, and/or to store test results 108 in database 110.

FIG. 2 is a flowchart of an exemplary process for creating a library. With reference now to FIG. 2, an exemplary process 200 for creating a library suitably includes creating individual library elements (step 202), testing the individual elements (step 204), storing test results (step 206), verifying test results (step 210) and setting appropriate flags (step 212) prior to combining approved components into the library (step 214).

Cells or other components may be created (step 202) with any design tool such as the AUTOCAD computer aided design program available from Autodesk Inc. of San Rafael, Calif. or any of the various design tools available from the Cadence corporation of San Jose, Calif. Typically, such cells are represented as an electronic design file that may be stored within the file system of a personal computer, workstation or other computer as described more fully below. Frequently, a business group manages and tracks the cell design process using a project management tool such as the suite of project management tools available from Synchronicity, Inc. of Marlboro, Mass. The Synchronicity DESIGNSYNC program, for example, may be used to track changes made to cell designs as well as different versions of the cell design. Similarly, the Synchronicity PROJECTSYNC program may be used to monitor issues that may arise during the cell design process. Of course other project management tools such as ClearCase from Rational Software Corp. of Cupertino, Calif. may be used within different embodiments, or may be eliminated altogether.

During design process 200, various manual and automatic tests may be performed to verify the correct design and performance of the cell, or to otherwise verify the status of each cell (step 204). Examples of tests that may be performed using various software tools include modeling, simulation, logic optimizations and the like. Many conventional testing products for use with design cells are readily available including the various simulation and testing tools available from Cadence, Synopsis, Verilog, Avanti, Simplex and others. Examples of manual tests include manual checks of data sheets and other documentation to identify any omissions, misspellings or typographical errors, pinout errors, graphical inconsistencies (e.g. pinouts not properly on grid, confusing layout, etc.), inaccuracies and/or the like. To identify such errors, a human operator typically manually reviews an electronic or hard copy of the document to visually identify any issues for correction or completion. Of course the actual manual and/or electronic tests performed to detect the status of some or all of the components will vary significantly from embodiment to embodiment.

The results of tests conducted in step 204 may be maintained in any convenient format and electronically stored for later use (step 206). Results may be stored in any sort of electronic record such as a metadata file, a tag, a “flat” file or in any other data format. The electronic record of test results may be maintained as an ASCII or other “flat” file maintained within a host file system, for example. Alternatively, test results may be maintained as “tags” in a DESIGNSYNC metadata file, as XML tags, or in any other format. In an exemplary embodiment using the Synchronicity project management suite, for example, the DESIGNSYNC program may be configured such that user-definable tags associated with each desired test for each cell are stored within a metadata file that may be stored in a file system directory with the cell design data. Such tags are easily and readily defined using conventional user-interface functionality provided by the DESIGNSYNC program. In practice, users may manually enter test results (e.g. “test performed”, “test successful”, “test failed”) into the metadata associated with a particular cell using conventional DESIGNSYNC interfaces. Alternatively, scripts or other instructions could automatically place test results into appropriate metadata files as tests are performed. It will be appreciated that the term “metadata” as used herein refers to any data that contains information or descriptive material about other data. Metadata may therefore be implemented with tags, files, pointers, objects and/or any other data format. An example of data stored in a metadata file is shown in FIG. 3, discussed more fully below. In certain embodiments, test results and/or textual comments may be incorporated into the metadata for later review.

With continued reference to FIG. 2, the process of building a library (step 216) suitably includes verifying test results (step 210) to validate the cell (step 214). Criteria used to validate the cell varies from embodiment to embodiment, but in an exemplary embodiment a validated cell is considered to have been fully tested and to have successfully completed each of the tests prior to including the cell in the resultant library (step 214). The process of verifying (i.e. checking) the metadata to determine if all testing is complete and successful may take place in any manner. In the exemplary embodiment shown in FIG. 2, each cell is individually verified (step 210) and an optional “approve” or “reject” flag is set based upon comparisons of the metadata contents with pre-determined rules (step 212). The flag may be set within an administrative program such as any of the Synchronicity applications, or within a script or other application. A PERL or PHP script, for example, could be written to execute various checks using simple “IF-THEN” logic, or using any other programming technique. In alternate embodiments, the “approve” or “reject” flags are omitted entirely and results are maintained in memory or storage in any format. When a cell has been checked and found to be suitable for inclusion into a library, the cell is said to be validated. The process of checking/verifying a cell, then, ideally results in the cell being validated for use in a cell library.

Again, cells may be validated (i.e. approved and/or rejected) in any manner. The particular tests performed or the particular results that are appropriate for inclusion into any particular library, for example, may be configurable according to appropriate rules. These pre-determined rules or other criteria used to approve or reject various cells may vary widely from embodiment to embodiment. In an exemplary embodiment, each cell is checked to ensure that certain manual and/or automatic tests are performed, and that each completed successfully. Such tests may be performed using any scripting or programming language using, for example, conventional IF-THEN logic. In other embodiments, metadata merely contains binary “checkboxes” that may be set if a test executes successfully and cleared if a check is has not been performed or completed unsuccessfully. In such embodiments, the verification process would entail checking that each relevant field is set in the cell metadata prior to incorporating the cell into the library. Any technique for verifying that a particular cell or group of cells has been successfully tested could be used to implement steps 210/212. Further, any grouping, looping or iteration technique 208 could be used to process the various cells incorporated into the library. In the embodiment shown in FIG. 2, a WHILE-DO structure is shown, although any IF-THEN, FOR-NEXT, or other looping structure could be used in an alternate embodiment. Further, it is not necessary that all embodiments incorporate the looping functions shown in FIG. 2. Cells could be validated “on the fly” as the library incorporation process executes, for example, thus eliminating the need to separately check each cell prior to the incorporation process.

Validated cells may be incorporated into a library (step 214) according to any technique. Many commercially-available programs such as the Synchronicity suite provide cell incorporation functionality. Alternatively, any conventional library-creation process may be used. Various techniques for combining multiple cells into a library are discussed in the U.S. Patents previously incorporated by reference, for example. Further, it should be reiterated that the resultant library need not be a cell library for use with integrated circuit design; any type of library or other compilation may be created.

FIG. 3 is a data structure used to maintain test results in an exemplary metadata implementation. With reference to FIG. 3, exemplary metadata 108 suitably includes one or more fields corresponding to various tests performed on design data 106 (FIG. 1). As noted above, each of the data fields noted may be implemented as tags or other data structures within a file associated with design data 106. In an exemplary embodiment, data fields correspond to various tests conducted upon design data 106. Various entries may correspond to the completion of various tests (such as SPICE modeling, VERILOG netlisting, and the like), the completion of various manual checks (e.g. documentation checks, layout checks and the like), or other tests. Although the various fields shown in FIG. 3 are shown to be binary (e.g. “yes/no”, “complete”/“incomplete” or the like) in nature, other fields may contain textual input for comments from a user. Such comments may provide more detail about test results, for example, or may indicate additional tests that need to be completed, or may simply record dates or times that tests were completed. The various fields/tags within metadata 108 are suitably completed based upon data input by a user of host system 102, for example, or automatically recorded by a simulation or other testing application.

FIG. 4 is a pseudo-code implementation of an exemplary administrative application 104. With reference now to FIG. 4, an exemplary application 104 suitably checks the various cells to be included in a library prior to compilation. The exemplary embodiment includes instructions for initializing a counter or flag to an initial value (e.g. “TRUE”) prior to checking that each of the various test have been performed, and that each test completed successfully. As stated above, the actual routine used to process the various checks may vary widely. The validation process, for example, may not include separate checks for test completion and test success, since these factors may be combined in various embodiments of metadata 108. Moreover, the actual coding used to implement application 104 will vary widely; application 108 may be created using any programming or scripting language.

The corresponding structures, materials, acts and equivalents of all elements in the claims below are intended to include any structure, material or acts for performing the functions in combination with other claimed elements as specifically claimed. Of course other embodiments and applications of the systems and techniques described herein may be formulated without departing from the scope of the present invention. The scope of the invention should be determined by the appended claims and their legal equivalents, rather than by the examples given above. The steps recited in any method claims may be practiced in the order recited, or in any other order. No elements or components described herein are necessary to the practice of the invention unless expressly described as “essential” or “required”.

What is claimed is:

1. A method of creating a cell library, the method comprising:
for each of a plurality of cells:
determining a status of said cell; and
indicating said status of said cell with an electronic record;
checking said electronic record associated with each of said plurality of cells to validate each of said cells; and
compiling said validated plurality of cells to create said cell library.

2. The method of claim 1 wherein said determining step comprises manually checking a data sheet associated with said cell.

3. The method of claim 1 wherein said determining step comprises performing a series of electronic tests on said cell.

4. The method of claim 3 wherein said indicating step comprises recording the results of said series of tests in said electronic record.

5. A method of creating a library, the method comprising:
testing a library component;
recording results of said testing in a data file associated with said library component;
verifying that said data file is complete and free of error indications, and
incorporating said library component into said library if said verification is successful, and otherwise rejecting said library component from said library.

6. The method of claim 5 wherein said testing step comprises electronically modeling said library component.

7. The method of claim 5 wherein said testing step comprises manually verifying the accuracy of a data sheet associated with said library component.

8. The method of claim 5 wherein said verifying slip comprises determining if said data file is complete.

9. The method of claim 5 wherein said verifying slip comprises determining if said data file contains any error indicies.

10. A system for creating a cell library, the system comprising:
an input device configured to receive inputs from a user;
a database configured to store cell design data and metadata associated with said cell design data; and
a digital storage medium containing computer-executable instructions stored thereon, wherein said instructions are configured to receive said inputs from said input device, to store said inputs in said metadata, and to integrate said cell design data as a function of said metadata to create said cell library.

11. The system of claim 10 wherein said instructions are further configured to simulate said cell design data and to record simulation results in said metadata.

12. The system of claim 10 wherein said inputs comprise indicia of results obtained from a manual review by said user of data sheets associated with said cell design data.

13. A method of creating a cell library, the method comprising:
testing each of a plurality of cells to determine a status of said cell and to record said status in a data file associated with said cell; and
compiling said plurality of cells to create said cell library, wherein said compiling step comprises verifying said data file for each of said plurality of cells and including in said cell library only those cells having an associated data file that is free of error indicia.

14. A method of creating a library, the method comprising:
testing a library component to obtain test results;
recording said test results in a data file associated with said library component;
verifying that said data file is valid, and
incorporating said library component into said library if said data file is valid, and otherwise rejecting said library component from said library.

15. The method of claim 14 wherein said data file is verified to be valid if said test results are complete.

16. The method of claim 14 wherein said data file is further verified to be valid if said test results are favorable.

17. A method of creating a cell library, the method comprising:
testing a cell to obtain test results;
recording said test results in a metadata file associated with said cell;
checking said metadata file to validate said cell; and
incorporating said cell into said library if said checking step determines that said metadata file is valid, and otherwise rejecting said cell from said library.
